(19) United States
(12) Patent Application Publication
(10) Pub. No.: US 2006/0036696 A1
(43) Pub. Date: Feb. 16, 2006

(54) Managing email communications using email tagging

(76) Inventor: Mark Edmund Maresh, Grand Ledge, MI (US)

Correspondence Address: LALLY & LALLY, L.L.P., P. O. BOX 684749, AUSTIN, TX, 78768-4749, US

(21) Appl. No.: 10/917,810

(22) Filed: Aug. 13, 2004

(51) Int. Cl. G06F 15/16

(52) U.S. Cl. 709/206

(57) ABSTRACT

A computer program product for managing email communications includes code to incorporate email tags into an email. The email tags uniquely identify the corresponding email and an email family of which the email is a part. A user interface uses the email tags to permit a user to view the email family in a graphical manner illustrating the relationship among emails in the email family. Each email tags may further identify all direct email ancestors, if any, of its corresponding email communication. The user interface facilitates additional management tasks oriented to a family of emails including trimming branches in the email family to reduce redundancy and modifying last generation emails to include all attachments of the email's ancestors. The email tags might include an index portion appended to a base portion where the base portion uniquely identifies the original email and the index portion identifies an email's director ancestry path.

### BACKGROUND

1. Field of the Present Invention

The present invention is in the field of email communication and more particularly managing a series of related email communications.

2. History of Related Art

Email is a ubiquitous fixture in home, business, education, and government applications. In the context of the present invention, emails are broadly classifiable into two categories, namely, originating or original emails and responsive emails. Responsive emails include two main categories: reply emails and forwarded emails. Each of these categories includes subcategories such as reply-to-all emails, reply-without-history emails, forward emails with and without attachment emails and so forth.

Anecdotal evidence suggests that a substantial percentage of all email communications are responsive emails and that “interactive” email communication is extremely prevalent. Interactive email communication refers generally to the practice of initiating a presentation or discussion of a particular topic or set of topics with a first or original email that prompts at least one and typically multiple replies, responses to the replies, and so forth. As used in this disclosure, an interactive communication identifies all email communications that can trace their origin, either directly or through one or more intermediate emails, to a common email (the original email). An interactive email communication may also be referred to herein as an email family to emphasize the relatedness of the emails comprising the family. The popularity of interactive email communication is attributable, at least in part, to the ease with which responsive emails, which include all of the content of the preceding emails, can be propagated to others.

An interactive email communication begins when an original email is composed and sent to one or more recipients. Each recipient of the original email may reply to the email, forward the email to a new recipient, or both. Each recipient of a reply or forwarded copy of the original email may likewise reply to the email or forward the email to another recipient. In this manner, a single original email may produce many “offspring.”

Despite the pervasiveness of interactive email communication, conventional email applications and services are generally lacking in useful facilities for managing interactive email communication. While conventional email applications may permit a user to sort emails based upon a sender's address or a subject line, for example, such crude features are only minimally useful in managing email communication in a manner that conforms to the manner in which email communication is being used. It would be highly desirable to implement a method and system that recognized the structure of interactive email communication and permitted user's to manage emails accordingly.

### SUMMARY OF THE INVENTION

The identified objective is achieved in the present invention with a computer program product (software) for managing email communication. The software includes code for determining whether an email is an original email or a responsive email and for incorporating or otherwise associating an original email tag with the email upon determining that the email is an original email. The original email tag uniquely identifies the corresponding email. The invention further code that, upon detecting a responsive email, retrieves the email tag from its parent email (its immediate direct ancestor), modifies the retrieved tag, and includes the modified tag in the responsive email. The modified tag preferably uniquely identifies the responsive email and all of its direct ancestor emails. The original email tag may include a base portion containing information indicative of a time stamp associated with the original email and further indicative of the author of the original email. In the case of responsive emails, the retrieved tag includes the base portion of the original email tag and an index portion where only the index portion is modified in each successive responsive email. The index portion of each successive responsive email may be formed by appending a character string to the index portion of the email's parent. In this manner the index portion of each responsive email includes the index portion of its parent email and other direct ancestor emails thereby facilitating identification of related emails.

In another embodiment, the invention is a computer program product for managing email communications that includes code for incorporating email tags into an email. The email tags uniquely identify the corresponding email and an email family, if any, of which the email is a part. A user interface uses the email tags to permit a user to view the email family in a graphical manner illustrating the relationship among emails in the email family. Each email tags may further identify all direct email ancestors, if any, of its corresponding email communication. The user interface facilitates additional management tasks oriented to a family of emails including trimming branches in the email family to reduce redundancy and modifying last generation emails to include all attachments of the email's ancestors. The email tags might include an index portion appended to a base portion where the base portion uniquely identifies the original email and the index portion identifies an email's director ancestry path.

### BRIEF DESCRIPTION OF THE DRAWINGS

Other objects and advantages of the invention will become apparent upon reading the following detailed description and upon reference to the accompanying drawings in which:

FIG. 1 is a conceptual illustration of an interactive email communication;

FIG. 2 illustrates an email tag according to one embodiment of the invention;

FIG. 3 illustrates email tagging for the interactive email communication of FIG. 1;

FIG. 4 is a flow diagram of a method of tagging email communications according to an embodiment of the present invention;

FIG. 5 illustrates an exemplary user interface for an email application supporting interactive email communication tagging according to the present invention; and

FIG. 6 is a table identifying the fields of a base portion of the email tag of FIG. 2.

While the invention is susceptible to various modifications and alternative forms, specific embodiments thereof are shown by way of example in the drawings and will herein be described in detail. It should be understood, however, that the drawings and detailed description presented herein are not intended to limit the invention to the particular embodiment disclosed, but on the contrary, the intention is to cover all modifications, equivalents, and alternatives falling within the spirit and scope of the present invention as defined by the appended claims.

### DETAILED DESCRIPTION OF THE INVENTION

Generally speaking, the present invention is concerned with tagging email communications in a manner that facilitates the management of such communications, and more specifically, facilitates management of email communications according to interactive email communication sequences. For purposes of brevity and clarity, the phrase “email communication” is synonymous with the word “email” as used in this disclosure. Each original email is tagged with an original tag. The original tag is preferably a unique or highly-likely-to-be unique indicator of the corresponding email. The original tag may be attached, appended, or otherwise included in the body or header of the original email. When an email responsive to the original email (or a descendant of the original email), is generated, the tag is extracted from the parent email (the email to which the current email is directly responsive). A modified tag is then created from the tag of the parent email and associated with the responsive email. The modified tag preferably indicates the tag of the parent email and all direct ancestors of the parent email while simultaneously uniquely identifying (or highly-likely-to-uniquely identify) the responsive email itself. In this manner, emails that comprise interactive email communication sequences are identifiable and manageable by a common “base” tag and appropriate appendices thereto.

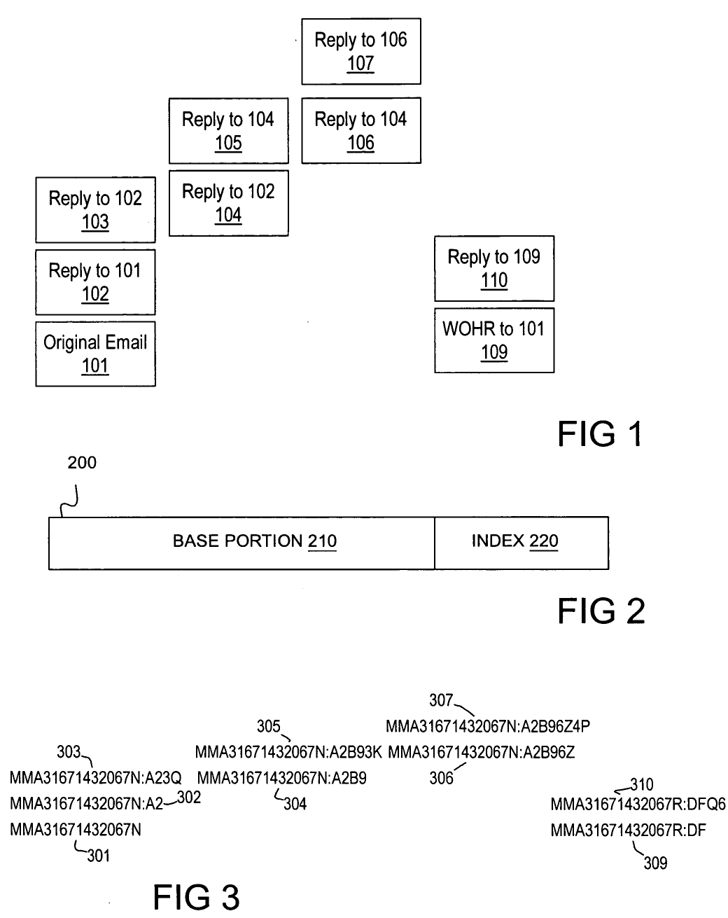

Referring now to the drawings, FIG. 1 is a conceptual illustration of an interactive email communication suitable for illustrating selected components of the present invention. In FIG. 1, interactive email communication sequence 100 includes a set of email communications identified by reference numerals 101 through 110. In this illustration, email 101 represents the original email (also referred to as the base email). Original email 101 represents an email generated by its author “from scratch” and not as part a reply or other response to an email received from another.

As illustrated in FIG. 1, original email 101 ultimately resulted in the creation of additional emails 102 through 110. Each of these emails is referred to for purposes of this invention as a responsive email. Responsive emails, as used in this disclosure, include reply emails and forwarded emails. Responsive emails may include emails of the “with-history” type and emails of the “without-history” type. A with-history responsive email signifies that the corresponding email includes the content of all of an email's direct ancestors. A direct ancestor email is any of the emails in the chain of emails to which the email under discussion is responsive. Responsive emails that are without history are treated distinctly as will be discussed below. In the illustrated example, emails 102 through 107 are with-history responsive emails while email 109 is a without history email. Email 110 is without history as to original email 101, but may be with history with respect to email 109.

Interactive email communication 100 as depicted in FIG. 1 may be qualitatively described as follows. Original email 101 is sent to one or more recipients by its author. A recipient of email 101 responds (email 102) to original email 101, most likely by reply (with history) to the author of email 101, but also by forwarding (with history) email 101 to another and including the original email author on the distribution list. A first recipient of email 102 responds (by reply or forwarding) to receipt of email 102 by replying with email 103. A second recipient of email 102 responds with email 104. A first recipient of email 104 responds with email 105 while a second recipient of email 104 responds with email 106. A recipient of email 106 responds with email 107. For purposes of this illustration, each of the emails 102 through 107 is assumed to be a with-history response. FIG. 1 also illustrates a case of a without-history response. Specifically, email 109 represents a without-history response to email 107 while email 110 is a with-history response to email 109.

Interactive email communication 100 as depicted in FIG. 1 illustrates that a single original email (101) may propagate a significant number of related emails (emails 102 through 110). Moreover, it is reasonable to assume that, as responsive emails, each of the emails 102 through 110 is related in some way to original email 101. A feature of the present invention recognizes the probable relatedness of the individual emails in an interactive email communication and incorporates an element into the emails that facilitates management of the interactive email communication as a whole. In the illustrated embodiment of the invention, the element that facilitates this management includes an email tag.

Referring now to FIG. 2, an email tag 200 according to the depicted embodiment of the present invention includes a base portion 210 and an index portion 220. A tag 200 is included in each email generated or received. The base portion 210 of a tag 200 is generated and assigned when an original email is created. Each tag 200 is configured to uniquely identify the corresponding email. In addition, each tag 200 is further configured to uniquely identify all of the direct ancestors, if any, of the corresponding email. A responsive email (with history) includes the base portion 210 and any index portion 220 of its parent email.

A conceptual representation of one implementation of base portion 210 of an email tag 200 suitable for use in the present invention is shown in FIG. 6. As a practical matter, the implementation of base portion 210 depicted in FIG. 6 does not strictly guarantee uniqueness, but is highly likely to uniquely identify the corresponding email. Specifically, base portion 210 depicted in FIG. 6 includes a set of seven fields 201 through 207, each of which has a corresponding value that depends on various factors including the author, sender, or originator of the original email, the date and time when the email was sent or created, and whether or not the email was an original email or with-history response or a without-history response.

The first field 201 of base portion 210 as depicted in FIG. 6 is a three digit field whose value is determined by the first three character's of the author's email address or user ID. Note that the author referred to here is the author of the original email in an interactive email communication (e.g., the author of original email 101 in FIG. 1). Using the first three characters of the author's user ID represents a compromise between achieving highly unique email tags and minimizing the size of each email tag. It is theorized that deriving an email tag from the first three characters of an author's user ID, in conjunction with date and time information (described below), yields a tag that is sufficiently unique for the vast majority of applications. Redundant email tags would occur only if two users, whose user IDs share the first three character in common, sent emails at the exact same time (within one second of accuracy). If a particular application requires a greater degree of uniqueness in its email tags, more characters from the user ID can be used. If absolute uniqueness is desired, for example, the entire email address of the author (including the domain name) could be used since duplicate email addresses are prohibited.

Fields 202 through 206 are determined by the time and date of the original email. Typically, these fields identify the time and date when the original email was sent, but they may alternatively indicate the time and date when the email was created, last modified, and so forth depending upon the implementation. The specific fields used in the depicted implementation include a one digit year field 202, a three digit Julian date field 203, a two digit hour indicator 204, and two digit minute indicator 205, and a two digit second indicator 206. The one digit year indicator used in the depicted implementation is determined by the last digit of the current year and is thought to adequately unique for its intended. Specifically, although the time and date fields 202 through 206 do not specify a time and date that is absolutely unique, they do specify a time that recurs only once every ten years. In the context of email applications, this degree of uniqueness is believed to adequate because it is unlikely that another original email will be created or sent exactly ten years (down to the second) after the creation or delivery of a previous original email. Moreover, it is also highly likely that most email communications will not be retained for ten or more years in most commercial applications given the rapid rate at which information becomes stale. In light of these considerations, the depicted implementation attempts to minimize the size of the tag 200 by using just a single digit for the year field 202. If additional degrees of uniqueness are required, however, a two digit year field would maintain uniqueness for 100 years, a three digit year field would guarantee uniqueness for 1000 years, and so forth.

The three digit Julian date field 203 uniquely indicates the day of year as a number between 1 and 366 inclusive. The Julian date beneficially requires only 3 digits compared to the four digits necessary to specify a day of month (two digits) and a month (two digits). The hour field 204 specifies the hour in military or 24-hour clock time while the minute and second fields 205 and 206 are self-explanatory.

The email type field 207, as its name suggests, indicates the type of the email and more specifically for purposes of this invention, whether the corresponding email is fully compliant with the described email tagging system. In one case of particular interest, the email type field is a one digit or possibly even a 1-bit (binary) value that indicates whether the corresponding email is compliant or non-compliant. A compliant email would be an email, whether original or responsive, generated by an application that supports the described email tagging and that is with-history in the case of responsive emails. A non-compliant email indication would be assigned to an email received from an application that did not support the described email tagging mechanism or to a responsive email that was without-history. Email type field 207 might convey additional information such as whether a response is a reply or forward, whether a response contains any previous attachments, and so forth depending upon the implementation. In the illustrated example, email type field 207 is a single digit field that is assigned a value of “N” for original emails and with-history responsive emails, while an “R” is assigned for without history responsive emails and emails received from non-supported applications.

Although a specific implementation has been described for the base portion 210 of an email tag 200 according to the present invention, other tagging schemes are within the scope of the present invention. However, a significant characteristic of the tagging method and mechanism under discussion that preferably should be duplicated in any other implementation is that the tag is able to uniquely identify the email itself, all of the email's direct ancestors, and all of the email's relatives.

For purposes of this disclosure, a direct ancestor of a particular email is any email in the chain of emails that preceded the particular email. Referring to FIG. 1, for example, the direct ancestors of email 107 include email 106, email 104, email 102, and email 101. Any such grouping of an email and all of its direct ancestors is referred to herein as a branch. An email's relatives, in contrast, refers to all emails that can trace their origin to a common email. Stated alternatively, an email's relatives include all emails that comprise an interactive communication such as interactive email communication 100 in FIG. 1. The ability of the email tagging mechanism proposed herein to uniquely identify an email and its ancestors and relatives provides the foundation for functionality that permits a user to manage interactive email communication sessions or sequences as a set of related communications.

Referring again to FIG. 2 and to the illustrative example depicted in FIG. 3, identifying an email and its ancestors and relatives is achieved according to the present invention using email tags 200 that include a base portion 210 and index portion 220 as depicted in FIG. 2. In the implementation described above with respect to FIG. 6, the base portion 210 is a fixed length character string that is determined when an original email is composed and that uniquely identifies the original email. Because all emails within an interactive email communication are descended from a common original email, the base portion 210 of the tags 200 for all emails within a particular interactive email communication is the same (with the exception of without-history responses as described below).

In one embodiment, index portion 220 is a variable length character string that is appended to base portion 210. Index portion 220 is preferably determined by appending a fixed length character string to the index portion 220 of the email's parent (the email's immediate direct ancestor). The index portion 220 of an original email is empty. For each “first generation” email (an email directly responsive to an original email), index portion 220 is a unique n-character string. For each second-generation email (an email directly responsive to a first generation email), index portion 220 is a 2n-character string, where the first “n” characters of the string is the index portion 220 of the email's parent and the second “n” characters is unique to the particular itself. For a third-generation email, index portion 220 is a 3n-character string having a unique n-character string appended to the 2n-character index portion of the email's parent, and so forth for subsequent generations of emails.

In the implementation illustrated in FIG. 3, “n” is equal to 2 so that the email tag for each first generation email has a 2-character index portion, the tag for each second generation email has a 4-character index portion, and so forth. The 2-character index strings appended to each new email may be randomly generated values. It is believed that a two character string provides adequate assurance of uniqueness since a 2-character string comprised of only numbers and letters can represent 1296 (36²) values, which is sufficient for most applications (i.e., rarely does any particular email generate anything approaching 1300 direct responses). If, however, a particular application requires additional levels of index uniqueness, 3-character (or more) strings may be appended to each email.

FIG. 3 depicts exemplary email tags 301 through 310 corresponding to the email communications 101 through 110 as depicted in FIG. 1. The email tag 301 for original email tag consists of a base portion derived as described above with respect to FIG. 6. Email tag 301 includes a 3-character user-based portion “MMA” that represents the first three characters of a particular author's email address or user ID. Email tag 301 further includes a string of 10 characters that indicate the date and time when original email 101 was created or sent (depending upon the implementation). The particular character string 3 167 14 32 06, indicates that original email 101 was created or sent in a year ending in “3” (e.g., 2003) on the 167th day of that year at 14:32:06 (6 seconds after 2:32 PM) of that day. The last character of email tag 301 (having a value of “N”) is discussed below.

In FIG. 1, email 102 is the only first generation email in interactive email communication 100 since no other emails were directly responsive to original email 101. The email tag 302 corresponding to email 102 includes a base portion taken from email tag 301 and a 2-character, randomly generated index portion having a value of “A2.” If additional first generation responses were made, each would have its own unique 2-character index portion appended to the base portion MMA3167143206N.

Email 102 in FIG. 1 prompted two direct responses, namely, email 103 and email 104. The email tags 303 and 304 for these second generation responses includes the base portion of original email 101, the index portion of their parent email (i.e., the “A2” of email 102) and unique 2-character strings appended thereto (“3Q” for tag 303 and “B9” for tag 304). Email 104 prompted two third-generation emails 105 and 106 whose email tags 305 and 306 have index portions “A2B93K” and “A2B96Z” respectively derived by appending randomly generated 2-character strings to the index portion of email tag 304. Finally, email 106 prompted a fourth generation email 107 whose index portion is an 8-character string determined by appending the randomly generated 2-character string “4P” to the index portion of email tag 306 (“A2B96Z”).

Referring to email 109 and its corresponding email tag 309, email 109 represents a without-history reply to email 107. A without-history reply, as its name implies, is a reply that does not contain the content (body) of its direct ancestors. It is useful to identify without-history replies as such because there is a useful presumption in some applications involving management of related emails that each email contains all of the content of its predecessors. This presumption is useful because, when true, it enables a user to determine all of the information in a particular branch of an interactive communication by looking only at the last generation email in the branch. Thus, for example, email 107 contains all of the content of emails 106, 104, 102, and 101.

When the with-history presumption is not true because a reply is without-history, the implementation illustrated in FIG. 3 and FIG. 6 notates the email with a tag 200 that includes an “R” in the email type field 207. Thus, the base portion of email tag 309 is modified from the base portion of original email tag 301 by replacing the last character “N” with an “R.” Email tag 309 still includes the portion of email tag 301 that uniquely identifies original email 101 and, more generally, interactive email communication 100 so that email 109 is identified as belonging to or being a part of interactive email communication 101.

A tagging convention similar to that described for email 109 applies to responsive emails that originate from an application that does not support the tagging mechanism of the present invention. The email tagging mechanism of the present might be implemented as an extension of existing email protocols. In such cases, it is important to implement the tagging mechanism in a manner that does not prevent communication with persons using non-supported email applications. The emails tags 301 through 310 described herein might, for example, be embedded within a user-definable field in a header of the email (that is preferably ignored by non-supported applications), appended to the body of the email analogous to an attachment, or in another manner that does not conflict with existing email protocols, services, and applications.

When a responsive email is received from a person using a non-supported application, an email tag might be assigned to the email by the recipient application. Assuming that the email tag in the original email, is implemented in a manner that is transparent to the non-supported application, the responsive email returned by the non-supported application should retain the original email tag. In this case, the support application might modify the email tag of the responsive email by converting the email type field from “N” to “R” in the same manner as was done for the without-history reply 109. In other implementation, different designators may be used to identify cases of without-history responses generated by supported applications from responses generated by non-supported applications.

Returning to the case of the without-history reply 109, the implementation depicted in FIG. 1 and FIG. 3 appends a 2-character index portion (having a value of “DF” to the modified base portion (the base portion containing the “R” value in the email type field). The index portion ensures (or is highly likely to ensure) uniqueness of the email tag for email 109. When an email 110 is generated in response to email 109, the tag 310 for email 110 is derived by appending an additional 2-character string to the index portion of tag 309 as was done for the email tags 302 through 307 described above. Note that the base portion of email tag 310 retains the “R” value in the email type field to convey that email 110, like its parent email 109, does not contain historical content.

Portions of the present invention are most likely embodied as a sequence or set of computer executable instructions (computer software) for tagging email communications and using the emails tags to manage interactive or otherwise related email communication. In such embodiments, the software may be stored on a computer readable medium such as a hard disk, floppy diskette, CD ROM, magnetic tape, or other form of persistent storage. During times when such software is being executed by a computer, portions of the software may reside in a volatile computer readable medium such as a DRAM-based system memory or an SRAM-based cache memory.

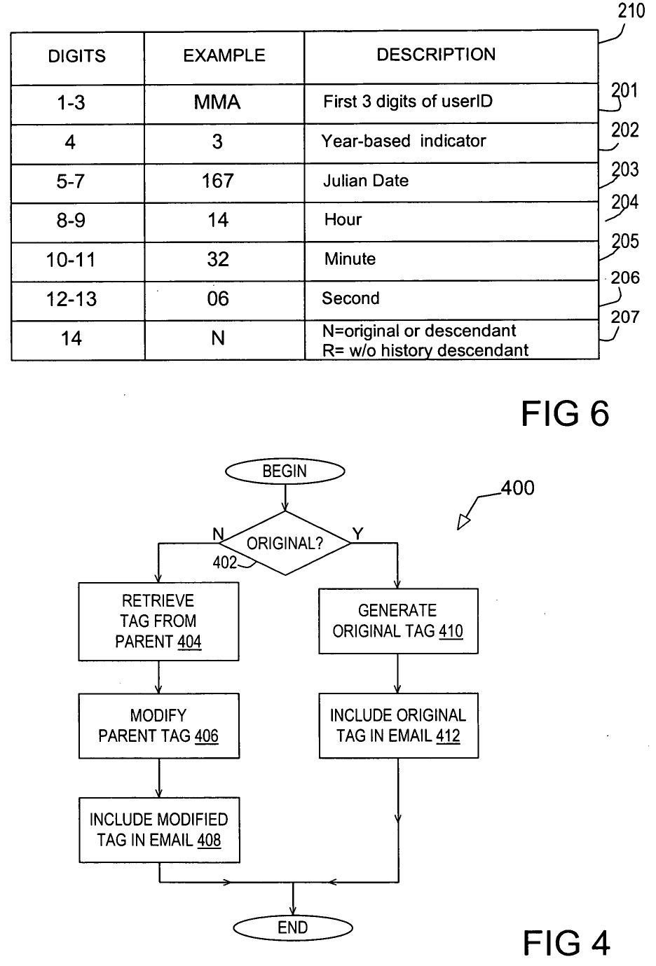

Referring now to FIG. 4, a flow diagram illustrating one embodiment of a method or process 400 for tagging email communications according to the present invention is depicted. In the depicted embodiment, method 400 includes an initial block 402 where, in response to the creation of an email, it is determined whether the created email is an original email or a responsive email. If the email is an original email, an original email tag is generated in block 410. Generation of the original tag in block 410 is preferably achieved by generating a tag such as email tag 200 described in FIG. 2 and FIG. 6. The original email tag is preferably highly unique (i.e., able to uniquely identify the corresponding email) and may include elements derived from the author of the original email and a time stamp associated with the original email. The original tag is then incorporated (block 412) into or otherwise associated with the original email. As indicated previously, the email tag may be included in the header or body of the email or appended to the body analogous to an attachment. Associating the email tag with the email is preferably done wherein the email tag does not prevent the email from being distributed and accessed via legacy email protocols and applications.

If it is determined in block 402 that the email being created is a responsive email such as a reply email or a forwarding email, the email tag is retrieved (block 404) from the parent email where the parent email is the email to email under discussion is responding. The retrieved email is then modified as represented by block 406. Modification of the retrieved email preferably results in a modified email having at least three significant characteristics. First, the modified email tag is capable of uniquely identifying the newly created email. In addition, the modified email tag should be able to identify the direct ancestors of the newly created email as well as all other relatives of the newly created email.

The implementation illustrated and described with respect to FIG. 3, achieves these results using a base portion of the email tag that is retained and remains unmodified by all emails (excluding without-history emails) descending from a particular original email and by appending an index portion to the base portion for all responsive emails. The index portion of any responsive email is derived in one embodiment by appending a unique character string to the index portion of the email's parent email such as was illustrated and described above with respect to FIG. 3. In this manner, the base portion identifies all of the email's relatives (by identifying the original email), the index portion as a whole uniquely identifies the email under construction, and the index components identify the direct ancestors of the email.

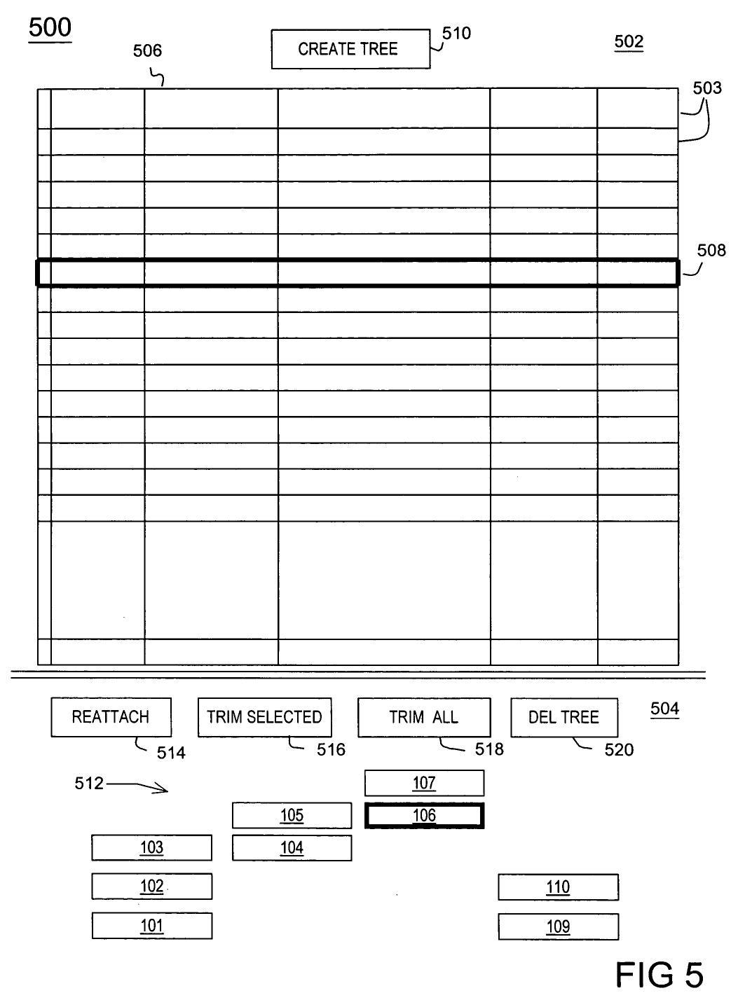

Email tagging as described above results in a collection or database of email communications that include email tags created in the described manner. One aspect of the invention is the use of the described email tags to facilitate email management tasks, especially tasks that are directed at managing related emails such as interactive email communications. Illustration of this aspect of the invention is attempted in FIG. 5, where an exemplary user interface 500, suitable for use in conjunction with tagged email communications, is depicted.

The depicted implementation of interface 500 includes a email inventory or database window 502 and a secondary window 504. Database window 502 includes elements found in most conventional email applications. Window 502 displays a collection 506 of email communications as a list of entries 503. Each entry 503 include different fields such as the sender's email address or user ID, the subject line of the email, the date sent, date received, size of the email, and so forth. The collection 506 of emails displayed by interface 500 might represent a subset of all the user's emails. The email application, for example, might incorporate folders such as an inbox folder, outbox folder, sent folder, draft folder, and trash folder. The user might create additional folders as well including folders for particular clients, projects, and so forth. For use in the context of the present invention, each email is tagged according to the technique described herein.

As shown in FIG. 5, a particular entry 508 has been selected and highlighted, presumably by a user interested in that email communication. User interface 500 provides features that facilitate management of interactive email communications. Specifically interface 500 includes a function button 510 that enables a user to generate a “family tree” that graphically depicts the selected email 508 in relation to all of the emails in the same family as email 508.

For purposes of illustrating the features of interface 500, the selected email 508 represents email 106 shown in FIG. 1. When a user selects email 508 and asserts or clicks the family tree function button 510, a graphical representation of the interactive email communication of which selected email 508 belongs is displayed in the secondary window 504. The family tree view of interactive email communication 100 (FIG. 1) shows each email in the communication in relation to each of the other emails. The graphical representation shown in secondary window 504 enables the user to visualize the selected email in relation to all other emails belonging to the same communication.

In addition, the implementation of secondary window 504 shown in FIG. 5 presents the user with additional functionality for managing interactive email communications. Specifically, secondary window 504 presents the user with a re-attach function button 514, a trim selected branch function button 516, a trim all branch button 518, and a delete tree function button 520. The re-attach function button 514 is configured to incorporate all historical attachments to the last email in a particular branch. More specifically, email attachments may or may not be included in responsive emails. It is commonplace, for example, for many email applications to omit attachments in reply emails under the assumption that the recipient of the reply email already has the attachment. Thus, the “tip” of any branch of emails (i.e., the highest generation email in a particular branch) may or may not include all of the documents that were attached in any of the emails from which the tip email is descended. Reattach function button 514, when asserted causes the email application to search all of the emails in a branch for attachments and to incorporate those attachments into the last generation email of the branch (assuming that the historical attachments have not been deleted or made otherwise inaccessible or undetectable).

The trim selected branches function button 516 and the trim all branches function button 518 provide differing scopes of similar functionality. An email branch is trimmed according to the present invention, by deleting all emails in a branch except the last generation email (which is presumed to contain all of the content of the entire branch). If, for example, the user clicks trim selected function button 516 while email 106 is selected, one embodiment of the user interface would delete all emails in the branch except the last generation email. Trimming beneficially reduces duplicative copies of emails communications thereby conserving valuable disk space. Another implementation might delete all emails in the branch except the selected email and its descendants. In the first implementation, selecting entry 508 (email 106) in database window 502 and clicking trim selected function button 516 in secondary window 504 would result in the deletion of emails 106, 104, 102, and 101, which represent the direct ancestors of the last generation email (email 107) belonging to the branch of which the selected email (email 106) belongs. In the second implementation, selecting email 508 and clicking trim selected function button 516 would delete emails 104, 102, and 101 (the direct ancestors of the selected email).

The trim-all function button 518 deletes all emails belonging to the selected email's family except for the last generation emails of each branch. Asserting trim-all function button 518 in the illustrated example would result in the deletion of all of the emails shown in secondary window 504 except for emails 103, 105, 107, and 110. This feature beneficially produces the minimum set of emails from which the entire interactive communication can be thereby conserving maximum disk space without loss of information. The trim functions of buttons 516 and 518 might incorporate an internal re-attach function to prevent unintended loss of attachment information when a branch is trimmed. The delete tree function button 520, when asserted deletes all emails in the family, with the possible exception of the highlight email depending upon the implementation.

All of the function buttons shown in FIG. 5 rely on the email tagging mechanism of the present invention. By conveying information about an email's identity, the identity of all emails in a branch or chain of emails and all emails descended from a common original email, the emails tagging mechanism permits the user interface to manipulate families and branches of emails.

It will be apparent to those skilled in the art having the benefit of this disclosure, therefore, that a mechanism for tagging email communications to facilitate email communication management is disclosed and enabled. It is understood that the form of the invention shown and described in the detailed description and the drawings are to be taken merely as presently preferred examples. It is intended that the following claims be interpreted broadly to embrace all the variations of the preferred embodiments disclosed.

What is claimed is:

1. A computer program product comprising computer executable instructions for managing email communication, said instructions stored on a computer readable medium, comprising:
computer code means, responsive to creation of an email communication, for determining whether the email communication is an original email or a responsive email;
computer code means, responsive to determining that the email is an original email, for generating an original email tag to be associated with the email and including the tag in the email wherein the original email tag uniquely identifies the corresponding email; and
responsive to determining that the email is a responsive email:
computer code means for retrieving an email tag from a parent email, wherein the parent email is the immediate direct ancestor of the responsive email; and
computer code means for modifying the retrieved tag and including the modified tag in the responsive email communication, wherein the modified tag uniquely identifies the responsive email and all direct ancestors of the responsive email.

2. The computer code means of claim 1, wherein the code means for generating the original email tag comprise code means for including in the original email tag a base portion having information indicative of a time stamp associated with the original email and further indicative of the author of the original email.

3. The computer code means of claim 2, wherein the code means for modifying the retrieved tag includes code means for appending a character string to the retrieved tag, wherein the content of the retrieved tag is retained in the modified tag.

4. The computer code means of claim 2, wherein the retrieved tag includes the base portion of the original email tag and an index portion and wherein the code means for modifying the retrieved tag comprises code means for modifying only the index portion of the retrieved tag.

5. The computer code means of claim 4, wherein the code means for modifying the index portion comprises code means for appending a character string to the index portion of the retrieved tag, wherein the index portion of the modified tag includes the index portion of retrieved tag.

6. The computer code means of claim 5, wherein the code means for appending a character string to the indexed portion of the retrieved tag comprises code means for appending a n-bit character string, wherein n is an integer greater than one and less than five.

7. The computer code means of claim 1, further comprising, responsive to a user submitting a view tree request via a user interface, computer code means for using the email tags to determine all emails related to a selected email and displaying all the related emails in a graphical manner emphasizing the relationship among the related emails.

8. The computer code means of claim 7, further comprising, responsive to a user submitting a trim branch request via the user interface, computer code means for using the emails tags to determine all emails in an email branch of which the selected email is a part and deleting all emails in the branch except a last generation email of the branch.

9. The computer code means of claim 8, further comprising, responsive to a user submitting a re-attach request via the user interface, computer code means for using the emails tags to determine all emails in the email branch of a selected email and attaching to the last generation email in the branch all email attachments contained in the emails comprising the branch.

10. The computer code means of claim 1, further comprising, responsive to determining that a responsive email is a without-history response:
computer code means for retrieving the email tag from the parent email; and
computer code means for modifying the retrieved tag and including the modified tag in the responsive email communication, wherein the modified tag uniquely identifies the responsive email and the original email.

11. A computer program product for managing interactive email communications, comprising:
computer code means for including in an original email an original email tag highly likely to uniquely identify the original email;
computer code means for including in an email descended from the original email an email tag that includes the original email tag and an index portion appended to the original email tag, wherein the index portion indicates the identity of the corresponding email and the identify of each direct ancestor of the corresponding email.

12. The computer program product of claim 11, wherein the code means for including the original email tag in the original email includes code means for generating an email tag based an indicator of the author of the original email and on a time stamp associated with the original email.

13. The computer program product of claim 12, wherein the code means for including the email tag in the descendant email, code means for appending a character string of an index portion of a parent email of the descendant email.

14. The computer program product of claim 13, wherein the character string appended to the index of the parent email is a randomly generated 2-character string.

15. The computer program product of claim 11, wherein the email tag of the original email is a fixed-length character string and wherein the index portion is a variable length character string having a length dependent on a generation level of the descendant email.

16. A computer program product for managing email communications, comprising:
computer code means for including an email tag in an email communication, wherein the email tag uniquely identifies the email communication and an email family, if any, of which the email communication is a part;
computer code means for providing a user with an interface configured to use the email tags to permit the user to view the email family in a graphical manner illustrating the relationship among email communications in the email family.

17. The computer program product of claim 16, wherein the email tag further identifies direct email ancestors, if any, of the email communication.

18. The computer program product of claim 17, wherein the interface is further configured to use the emails tags to permit the user to trim an email branch, consisting of a last generation email and all director ancestor emails of the last generation email, by deleting all emails of the branch except the last generation email.

19. The computer program product of claim 18, wherein the interface is further configured to use the emails tags to permit the user to attach to the last generation email, attachments of all emails in the email branch.

20. The computer program product of claim 19, wherein the interface is further configured to use the email tags to permit the user trim all email branches of an email family and to delete an entire email family.
